(19) United States
(12) Patent Application Publication
(10) Pub. No.: US 2011/0264413 A1
(43) Pub. Date: Oct. 27, 2011

(54) METHOD FOR REPAIRING AND/OR UPGRADING A COMPONENT OF A GAS TURBINE

(76) Inventors: Alexander Stankowski, Wurenlingen (CH); Lukas Emanuel Rickenbacher, Basel (CH); Simone Hövel, Ennetbaden (CH)

(21) Appl. No.: 13/030,301

(22) Filed: Feb. 18, 2011

Related U.S. Application Data
(60) Provisional application No. 61/306,661, filed on Feb. 22, 2010.

(51) Int. Cl. G06F 17/50

(52) U.S. Cl. 703/1

(57) ABSTRACT

In a method for repairing and/or upgrading a component (10′), preferably of a gas turbine, especially a blade (10′), which component has been deformed during operation, a simplification with cost advantages is achieved by a first nominal CAD model (M1) of the non-deformed component (10) being made available, by the deformed component (10′) being measured, and by the first CAD-model (M1), with the aid of the data determined on the deformed component (10′), being transformed into a second CAD model (M2) of the deformed component (10′) by morphing. A cutting line, which determines a cut-out in the component (10′), and also an insert piece, which can be inserted in the cut-out, is established in the second CAD model (M2). A cut-out is introduced into the component (10′) in accordance with the cutting line, an insert piece for inserting in the cut-out is manufactured in accordance with the cutting line, the manufactured insert piece is inserted in the cut-out, and the inserted insert piece is connected to the component (10′) in a materially bonding manner.

This application claims priority under 35 U.S.C. §119 to U.S. Provisional Application No. 61/306,661, filed 22 Feb. 2010, the entirety of which is incorporated by reference herein.

### BACKGROUND

1. Field of Endeavor

The present invention relates to the field of machining finished components, which are built in a modular manner or are monolithic or hybrid components. It also relates to a method for repairing and/or upgrading such a component, especially of a gas turbine.

2. Brief Description of the Related Art

Gas turbines, for reasons of good efficiency, today have operating temperatures in the hot gas range of over 1400° C. It is therefore not surprising that a large number of components of gas turbines, such as rotor blades, stator blades or combustor liners, are exposed to large thermal and mechanical loads. Since these components are customarily produced from expensive high-temperature materials, it is desirable to repair them instead of completely replacing them if they are damaged. Furthermore, there is frequently the need to upgrade already installed components in order to enhance them in their functioning mode or to adapt them to changing operating conditions.

A method for replacing parts of turbine blades is known from U.S. Pat. No. 5,269,057. In the case of this known method, a region of the blade, which is to be replaced, is identified and then removed by means of a non-conventional machining process. In the same way, a replacement piece is produced, provision being made for engagement elements with which the replacement piece is mounted in a form-fitting manner on the blade. The parts are then interconnected in a materially bonding manner. For cutting out the region, which is to be replaced, and the replacement piece, one and the same CNC program is used for operating a spark-erosion machine.

A method for repairing and/or modifying components of a gas turbine is disclosed in EP 1 620 225 B1, in which, first of all, at least one section of the component which is to be repaired or to be modified is machined out of the component, especially cut out. A data set is then created for a replacement part, which is to be produced, at least in the case of the initial repair or modification of this section of the component. The replacement part is subsequently produced by means of a rapid manufacturing process.

After, or even before, the machining out, especially cutting out, of the particularly damaged section and also, if applicable, of a tolerance section adjoining the damaged section, from the component which is to be repaired, a data set is created for the replacement part which is to be produced. In this context, a three-dimensional CAD data set is first of all created for the replacement part, which is to be produced. This 3D-CAD data set for the part, which is to be replaced, is then transformed into a machine data set. First of all, a check is carried out as to whether a 3D-CAD data set exists for the component, which is to be repaired or the component which is to be modified, but undamaged, or for a corresponding new part. If such a 3D-CAD data set exists for the undamaged component, then a check is then carried out as to whether firstly there is systematic damage of the component and whether secondly the geometry of the damaged component can be reproduced. In the case in which both a systematic damage of the component exists and at the same time the geometry of the damaged component can be reproduced, based on static evaluations of the extent of the damaged section of the component which is to be repaired and also taking into consideration a tolerance section adjoining the damaged section, the previously damaged material regions, and also highly stressed regions of the component during the repair considered, the required geometry of the replacement part which is to be produced can be derived and from it the 3D-CAD data set can be generated.

If, however, no systematic damage of the component, which is to be repaired, exists and/or the geometry of the component which is damaged or is to be modified cannot be reproduced, then reverse engineering of the component, or at least of the relevant component regions, is carried out. For carrying out the reverse engineering of the component or component region, first the particularly damaged section and also, if applicable, additionally the tolerance section adjoining the damaged section, are machined out of the damaged component which is to be repaired. A measurement of the component or component region is then carried out, for example by means of mechanical or optical measuring sensors or by means of computer tomography and subsequent surface feedback. As a result, a 3D-CAD data set of the component, or component region, which is damaged or is to be modified, from which the damaged section and, if applicable, a tolerance section, have been previously machined out, is obtained. From this 3D-CAD data set of the machined component or component region, the 3D-CAD data set of the replacement part, which is to be produced, is determined by forming a difference with the 3D-CAD data set of the undamaged component.

Such a reverse engineering, however, is altogether very costly.

### SUMMARY

One of numerous aspects of the present invention includes a method of the aforementioned type by which the disadvantages of the previously known methods can be avoided and a repair or upgrading of the component can be carried out in a particularly simple and inexpensive manner.

Another aspect of the present invention includes that a first nominal CAD model of the non-deformed component is made available, the deformed component is measured, the first CAD-model, with aid of the data determined on the deformed component, is transformed into a second CAD model of the deformed component by morphing, a cutting line, which determines a cut-out in the component, and also an insert piece, which can be inserted in the cut-out, are established in the second CAD model, a cut-out is introduced into the component in accordance with the cutting line, an insert piece for inserting into the cut-out is manufactured in accordance with the cutting line, the manufactured insert piece is inserted into the cut-out, and the inserted insert piece is connected to the component in a materially bonding manner.

Another aspect includes that the component has damage and/or a region, which is intended for an upgrade, and the damage or the region intended for the upgrade is removed from the component by introducing the cut-out into the component.

Another aspect includes that the deformed component is measured in its entirety by means of a non-destructive method.

In particular, in this case the deformed component is mechanically and/or optically scanned in a three-dimensional, external scanning process.

The internal structure of the deformed component is preferably also non-destructively scanned, especially by CT methods or ultrasonic methods, or determined on the basis of a few reference points, wherein in addition to the deformation of the external contour of the component the second CAD model also takes into consideration deformations of the internal structure of the component and also deformations of possible cooling holes.

In particular, in this case the second CAD model additionally also takes into consideration changes as a result of material loss, especially changes in the thickness of walls in the component.

Yet another aspect includes that the cut-out is introduced into the component by a mechanical machining process, especially by Electrical Discharge Machining (EDM).

According to yet another aspect, the insert piece has a geometry, which deviates from the geometry of the part, which is removed from the cut-out.

A further aspect includes that all associated internal and external deformations of the component are included in the geometry of the insert piece.

Another aspect includes that a CAD model is generated for the manufacture of the insert piece on the basis of the cutting line, and that the insert piece is manufactured in accordance with the generated CAD model, especially by casting, additive manufacturing processes, or a mechanical machining process, such as milling or electrochemical machining.

Another aspect includes that the insert piece is manufactured oversized at pre-specified points, and that the insert piece is subjected to postmachining after manufacture.

Yet another aspect includes that the inserted insert piece is connected to the component in a materially bonding manner by automatic or manual welding.

According to a further aspect, the inserted insert piece is connected to the component in a materially bonding manner by high-temperature soldering.

Another aspect includs that the component is postmachined with regard to the external contour after the insertion and materially-bonding connection of the insert piece.

### BRIEF DESCRIPTION OF THE DRAWINGS

The invention shall subsequently be explained in more detail based on exemplary embodiments in conjunction with the drawing. In the drawing

FIGS. 1-7 show different steps in the method for repairing and/or upgrading a component of a gas turbine according to an exemplary embodiment of the invention, wherein a new component (FIG. 2) is produced according to a nominal first CAD model (FIG. 1), while a damaged and deformed component from a gas turbine (FIG. 3) is measured (FIG. 4), an associated second CAD model with the measured data is developed from the nominal CAD model by morphing (FIG. 5), a cut-out in the component and a matching insert piece are defined on the basis of this second CAD model (FIG. 6), and finally a manufactured insert piece is inserted in the machined-out cut-out (FIG. 7).

### DETAILED DESCRIPTION OF EXEMPLARY EMBODIMENTS

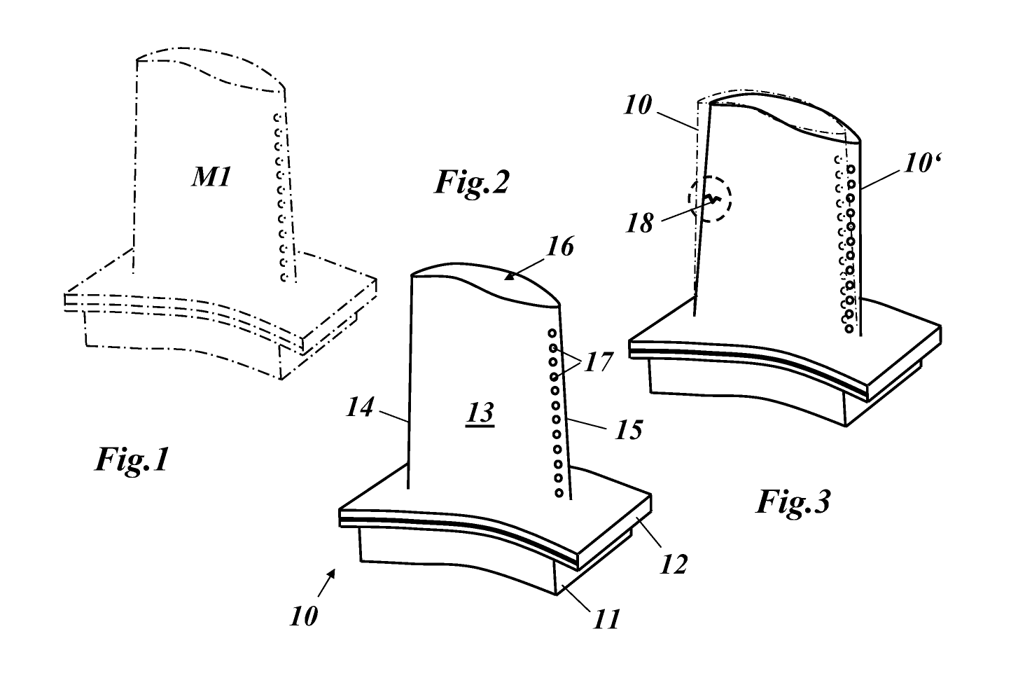

The invention is exemplarily explained in the following text based on a blade of a gas turbine. In FIG. 2, in a greatly simplified form, a blade 10 for a gas turbine is shown, having a blade root 11, a platform 12, and a blade airfoil 13 in a manner known per se. The blade airfoil 13 has a leading edge 15 and a trailing edge 14 and terminates at the top in a blade tip 16. In the example, which is shown, cooling holes 17, through which cooling air, which is introduced inside the blade airfoil 13 can discharge, are arranged in the region of the leading edge 15. The blade 10 of FIG. 2 is produced according to a nominal first CAD model which is schematically reproduced in FIG. 1 with dash-dot lines and with the designation M1.

If the blade 10 which is produced according to the CAD model M1 has been in use in its operating position in a gas turbine for a considerable time, it may have not only damage but may also be deformed on account of thermal and mechanical stress during operation. The new blade 10 then changes into a damaged and deformed blade 10′ which is shown in FIG. 3 with its deviation from the original shape. Exemplary damage 18 in the form of a crack is located in this case in the region of the trailing edge of the blade 10′.

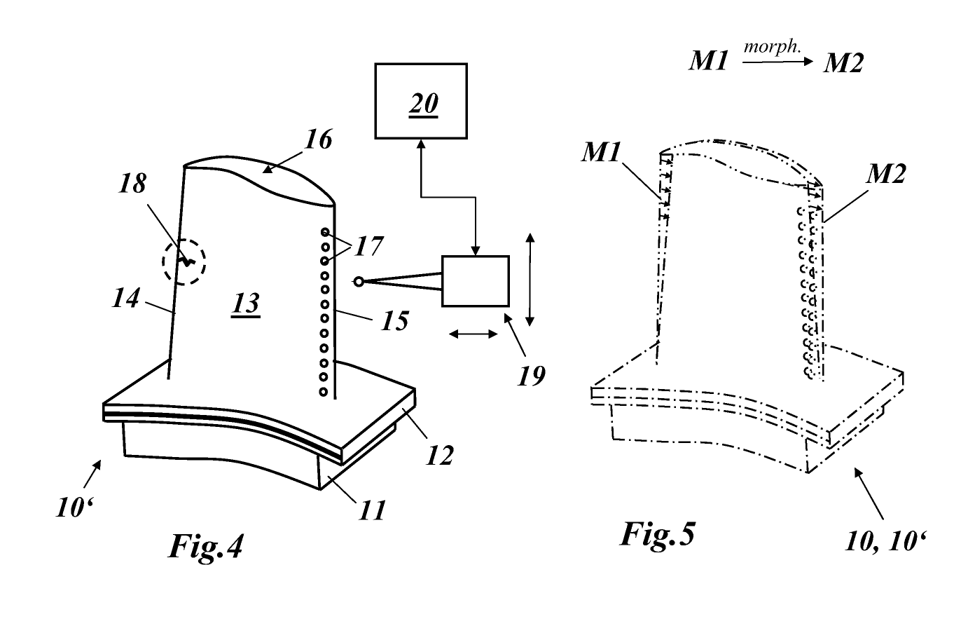

After removal from the gas turbine, the deformed and damaged blade 10′ is measured according to FIG. 4. This is carried out by a non-destructive method. A mechanical scanning device 19 with a scanning probe tip, with which the external contour of the deformed blade 10′ is traced, is shown as an example in FIG. 4. An associated evaluation unit 20 evaluates the measurement results. For this three-dimensional scanning process, a suitable optical scanning device can naturally also be used instead of the mechanical scanning device 19. With the aid of the measurement results of the scanning process, a second CAD model M2, which corresponds to the deformed blade 10′, is generated from the nominal CAD model M1 by so-called morphing (see FIG. 5).

The newly generated CAD model M2 includes deformations of the external contour, of the internal structures and of the cooling holes 17 on the basis of the previously determined scanning data. Material loss on the internal contour or the influence of a displacement of the blade core can be determined by non-destructive measuring methods, such as computer tomography (CT) or ultrasonic measuring, or based on a few reference points. Data from such measurements can also be recorded in the newly generated CAD model M2 of the deformed blade 10′.

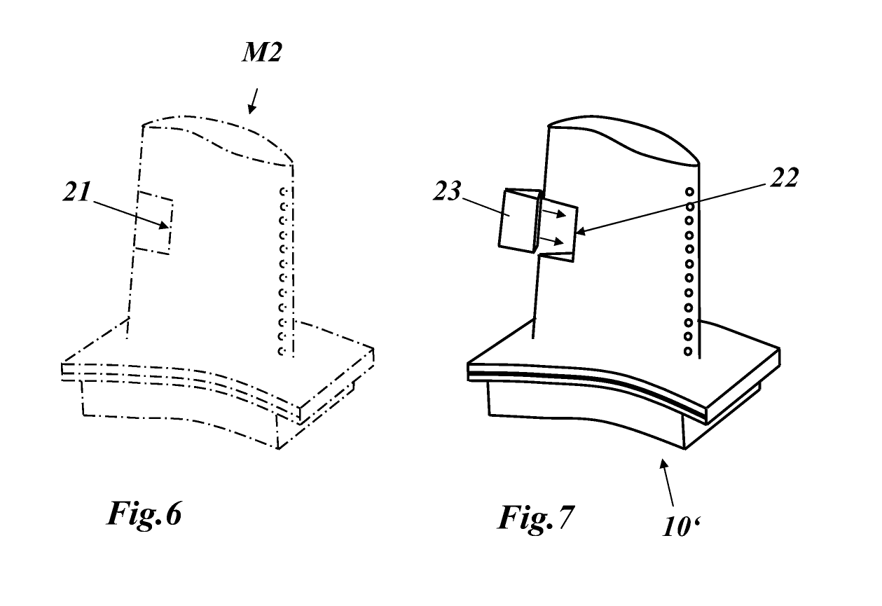

In the newly generated CAD model M2, a predetermined, freely selectable cutting line (21 in FIG. 6) can now be drawn in order to generate a CAD model of the geometry of a corresponding insert piece (23 in FIG. 7) which is to be produced. With this cutting line 21, the cut-out 22 (FIG. 7), which ensues as a result of removing the damaged region of the blade 10′, is established at the same time. In this case, no provision needs to be made for an additional oversize for the insert piece 23 in order to compensate for material loss during mechanical machining out of the cut-out 22. The cutting line—as in the case of the above-cited U.S. Pat. No. 5,269,057—may be complex and in particular formed so that a form-fitting connection between blade 10′ and insert piece 23 results.

The machining out of the cut-out 22 is preferably carried out by a mechanical machining process, such as spark erosion (EDM). The geometry of the region of the blade 10′ which is removed in the process does not need to be retained because it does not have to be scanned and is not required for generating a CAD model for the insert piece 23. Because the geometry is not required, even very complex cutting lines 21 can be selected.

The geometry of the insert piece 23 takes into consideration all information, which refers to deformation (external and internal contour, internal cooling structure, etc.). In each case, no reverse-engineering step is necessary in order to generate the CAD model for the insert piece 23. Nevertheless, the geometry of the insert piece 23 can be modified by CAD modeling in the case of special damage, or in order to be able to fulfill special requirements (design upgrade, new cooling structure, etc.).

The insert piece 23 is manufactured according to the generated drawings. This can be carried out by casting, additive manufacturing processes, or by a mechanical machining process, such as milling, or by electrochemical machining. An additive manufacturing process, for example selective laser melting, is preferably used.

The geometry or geometric details of the insert piece 23 (for example cooling ribs on the internal contour or cooling holes) can also be created within the scope of additional postmachining. As a result of this, geometric structures or details can be realized which otherwise would not be able to be realized within the scope of the production process (for example additive manufacturing processes, such as rapid manufacturing). For this postmachining, provision has to be made at the corresponding points for additional material or for an oversize.

According to FIG. 7, the manufactured insert piece 23 is then inserted in the corresponding cut-out 22 in the component 10′ and connected to the component 10′ in a materially bonding manner. For this, manual or automatic welding or high-temperature soldering can be used. Finally, after the connecting process, recontouring can be carried out in order to achieve an even or modified contour of the repaired component.

Methods embodying principles of the present invention can be altogether characterized by the following characteristic features and advantages:

The complete information of the nominal first CAD model is included in the second CAD model of the deformed component (external contour and internal cooling structure).

The drawing for the insert piece or replacement piece is derived from the second CAD model of the deformed component; for this, only establishing of a cutting line is required, but not reverse engineering.

Changes in the internal and external contours, of the internal cooling structure and also changes in the wall thickness, are included in the CAD data set.

The method can be carried out within the scope of conventional CAD software. Special software or interfaces are not required.

The generation of the CAD data and of the CAD model for the insert piece requires only a small outlay.

In general, no reverse engineering is required.

A comparison between the overall nominal geometry and the current geometry of the component is not necessary. A limitation to the part of the component in which the repair or the upgrade is to be carried out is sufficient.

The geometry of the removed component region does not have to be stored since scanning of this region for generating the drawing or generating a corresponding data set is not necessary. Since, for this reason, the component region does not have to be removed in one piece, different methods can be used for the removal.

For the same reason, more complex cutting lines can be used and increased flexibility in the process can be achieved.

On account of the high accuracy of the method, the insert piece, which is produced by additive manufacturing processes or mechanical (cutting) machining, requires no individual adjustment and little or no postmachining.

Casting processes have large manufacturing tolerances. Therefore, cast insert pieces require an adaptive machining step if a close gap tolerance is required during the materially bonding connecting process. In the case of manual welding, such an adaptive machining step is not required, but is of necessity in the case of high-temperature soldering on account of the creation of the capillary effect for the solder.

Method embodying principles of the present invention can be flexible and inexpensive so that they can be used for the definition and optimization of the cutting line, of the connecting method, and of fixing of the insert pieces. The geometry of the cutting line can be easily modified in the case of newly generated CAD data. Complex cutting lines, which are not restricted by any machining process, can also be modeled for trials. With an additive manufacturing process, slightly different geometries can be created for trials (both a section of the component with the cut-out as well as the insert piece). Trials with different cutting lines as well as with different connecting methods can be conducted, and the mechanical characteristics, such as LCF (low cycle fatigue), TMF (thermo-mechanical fatigue) and behavior under stress of long duration, can subsequently be tested, for example by thermoshock tests, tensile test, etc.

Naturally, the invention is not limited to the described exemplary embodiment.

It is applicable both to components of any type, which are built in a modular manner, and also to monolithic, and hybrid components.

### LIST OF DESIGNATIONS

10, 10′ Component, for example blade of a gas turbine

11 Blade root

12 Platform

13 Blade airfoil

14 Trailing edge

15 Leading edge

16 Blade tip

17 Cooling hole

18 Damage

19 Scanning device (mechanical and/or optical)

20 Evaluation unit

21 Cutting line

22 Cut-out

23 Insert piece

M1, M2 CAD model

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A method for repairing and/or upgrading a component which has been deformed during operation, the method comprising:
obtaining a first nominal CAD model of the non-deformed component;
measuring the deformed component and determining data from the deformed component;
transforming the first CAD model with the data determined from said measuring into a second CAD model of the deformed component, said transforming including morphing;
establishing a cutting line which determines a cut-out in the component and an insert piece which can be inserted into the cut-out, in the second CAD model;
forming a cut-out into the component based on the cutting line;
manufacturing an insert piece for inserting into the cut-out based on the cutting line;
inserting the insert piece from said manufacturing into the cut-out; and
connecting the insert piece after said inserting to the component in a materially bonding manner.

2. The method as claimed in claim 1, wherein:
the component has damage and/or a region which is intended for an upgrade; and
forming a cut-out comprises removing the damage or the region which is intended for the upgrade from the component.

3. The method as claimed in claim 1, wherein measuring the deformed component comprises measuring at least a small number of reference points on said deformed component using a non-destructive method.

4. The method as claimed in claim 3, wherein measuring the deformed component comprises mechanically, optically, or both, scanning using a three-dimensional, external scanning process.

5. The method as claimed in claim 4, wherein:
scanning comprises non-destructively scanning an internal structure of the deformed component, or determining said internal structure based on a small number of reference points; and
said transforming into a second CAD model comprises transforming based on deformations of the internal structure of the component and deformations of cooling holes.

6. The method as claimed in claim 5, wherein non-destructively scanning comprises CT or ultrasonic scanning.

7. The method as claimed in claim 5, wherein said transforming into a second CAD model comprises transforming based on changes as a result of material loss.

8. The method as claimed in claim 7, wherein said transforming based on changes as a result of material loss comprises transforming based on changes in a thickness of walls of the component.

9. The method as claimed in claim 1, wherein forming the cut-out comprises mechanical machining.

10. The method as claimed in claim 9, wherein mechanical machining comprises Electrical Discharge Machining.

11. The method as claimed in claim 1, wherein the insert piece has a geometry which deviates from the geometry of the part which is removed from the cut-out.

12. The method as claimed in claim 1, wherein manufacturing an insert piece comprises manufacturing an insert piece having a geometry based on all internal and external deformations of the component.

13. The method as claimed in claim 1, further comprising:
generating a CAD model for the manufacture of the insert piece based on the cutting line; and
wherein manufacturing the insert piece comprises manufacturing based on the generated CAD model.

14. The method as claimed in claim 13, wherein manufacturing the insert piece based on the generated CAD model comprises casting, an additive manufacturing process, or a mechanical machining process.

15. The method as claimed in claim 14, wherein said mechanical machining process comprises milling or electrochemical machining.

16. The method as claimed in claim 1, wherein manufacturing the insert piece comprises manufacturing the piece oversized at prespecified points, and further comprising:
machining the insert piece after said manufacturing.

17. The method as claimed in claim 1, wherein connecting the inserted insert piece in a materially bonding manner comprises welding.

18. The method as claimed in claim 1, wherein connecting the inserted insert piece in a materially bonding manner comprises high-temperature soldering.

19. The method as claimed in claim 1, further comprising:
machining the component with regard to the external contour after said inserting and after said connecting in a materially-bonding manner.

20. The method as claimed in claim 1, wherein the component is a component of a gas turbine.

21. The method as claimed in claim 1, wherein the component is a blade of a gas turbine.
